(19) United States
(12) Patent Application Publication
(10) Pub. No.: US 2023/0399591 A1
(43) Pub. Date: Dec. 14, 2023

(54) CLEANING SOLVENT BLENDS OF LOW GLOBAL WARMING POTENTIAL EXHIBITING AZEOTROPE-LIKE BEHAVIOR AND THEIR USE

(71) Applicant: Zynon Technologies, LLC, New Britain, CT (US)

(72) Inventor: Venesia Hurtubise, Wethersfield, CT (US)

(21) Appl. No.: 18/333,945

(22) Filed: Jun. 13, 2023

Related U.S. Application Data
(60) Provisional application No. 63/351,969, filed on Jun. 14, 2022.

(51) Int. Cl. C11D 7/50

(52) U.S. Cl. CPC C11D 7/5018

(57) ABSTRACT

Cleaning solvent compositions comprising, consisting essentially of, or consisting solely of, trans-dichloroethylene, 1-chloro-2,3,3-trifluoropropene and 1,1,2,2,3,3,4-heptafluorocyclopentane, and, optionally, one or both of surfactants and cosolvents, have utility as non-flammable, low-global warming potential, azeotrope-like cleaning fluids and carrier fluids for lubricants and the like. A method for cleaning articles of soiling substances comprises contacting the articles with the solvent composition by any suitable means such as a spray delivered by a propellant gas, or by contact with liquid and/or vapor solvent compositions, as in a conventional vapor degreaser apparatus, and removing the composition from the articles.

### CROSS-REFERENCE TO RELATED APPLICATIONS

This application claims priority of provisional patent application Ser. No. 63/351,969 filed on Jun. 14, 2022 in the name of Venesia Hurtubise, and entitled “CLEANING SOLVENT BLENDS OF LOW GLOBAL WARMING POTENTIAL EXHIBITING AZEOTROPE-LIKE BEHAVIOR AND THEIR USE”.

### BACKGROUND OF THE INVENTION

### Field of the Invention

The present invention concerns solvent-based cleaning compositions of the type used in industrial processes for cleaning a wide variety of items including metals and plastics in the metal-working, electronics and other industries. These solvent-based cleaning compositions are non-flammable and azeotrope-like, and are composed of non-ozone-depleting, low global warming potential ingredients.

### Description of Related Art

Solvent blends are used in industrial processes for cleaning a wide variety of soiling substances and residues (below sometimes referred to as “soils” or “soiling substances”). The electronics industry typically cleans fluxes, solder pastes, adhesives and coatings from a variety of devices before and after assembly of components. Such devices may comprise one or more of a wide range of materials comprising metal, ceramic and synthetic polymer (plastic) substrates and components. Metal working operations must remove lubricant oils and soaps, grinding media and greases from metal surfaces. Many of these soils are very difficult to strip from metal surfaces, especially with non-aqueous cleaners.

Of special interest are non-flammable blends of solvents that provide a cleaning solvent which can be used safely in aerosol packages, or as wiping fluids or in bulk cleaning tanks, for example, in vapor degreasing (“VDG”) units. Typically, these cleaning solvents comprise halogenated compounds that are either non-flammable themselves or can be rendered non-flammable in a mixture with other halogenated compounds. For example, it is known to use chlorinated hydrocarbons, such as flammable trans-dichloroethylene (TDCE), as the high solvency component with fluorinated components that serve to render the cleaning solvent blend non-flammable. In addition, and especially for VDG applications, the cleaning solvent blend should be an azeotrope or exhibit azeotrope-like behavior and be non-flammable, so that the vapor is also non-flammable. Therefore, it is highly desirable that the azeotrope not significantly fractionate after distillation, condensation and re-mixing, as happens in a vapor degreaser (“VDG”). That is, the component ratios should be nearly the same or at least not drastically changed in the boil sump as in the rinse sump in a VDG; or boil flask and receiver over the course of a full distillation.

The industry seeks to maximize the cleaning power of its products, often defined as the Kauri-Butanol index (“KB value”). A high KB value indicates high cleaning power for a solvent component or solvent blend. In order to attain a high KB value, the concentration of TDCE, or other high KB value components in the blend is made as high as is feasible. However, the solvent blend becomes more difficult to render non-flammable as the amount of the high KB value component in the composition is increased. A significant advance in the art was made by Dupont Corporation with the introduction of an azeotrope-like blend of 4 wt % by weight of methylperfluoroheptene (MPHE) ethers, 0.8 wt % Vertrel XF and 95.2 wt % TDCE, offered as Opteon SF79 by Chemours. This is currently the highest concentration of TDCE in a commercial product. However, the high TDCE concentration adversely affects flammability, that is, the Opteon SF79 solvent is more flammable than desired.

Raymond Wu et al. Patent Application Publication US 2022/008992 A1 published on Mar. 24, 2022 discloses quaternary azeotrope or azeotrope-like compositions comprising transdichloroethylene (“TDCE”) and three or more additional components. The TDCE may be present in the amount of 75-85 wt % (paragraph [0065], the second component may be a hydrofluoroolefin which, among others, may be 1-chloro-3,3,3-trifluoropropene (paragraph) [0041], the third component may be, among others, heptafluorocyclopentane (paragraph [0078], and the fourth component is selected from C₁-C₆ alcohols, C₆-C₈ alkanes, etc., as shown in paragraphs [0082], [0086], and [0088].

Robin et al. Patent Application Publication US 2016/0326468 A1, published on Nov. 10, 2016, discloses in paragraph a composition comprising from 0.1 to 8 weight percent methylperfluoroheptene ethers, from 90 to 99 weight percent trans-1,2-dichloroethylene and from 0.6 to 2 weight percent of a fluorocarbon selected from a very large group which includes heptafluorocyclopentane.

U.S. Pat. No. 8,410,039 to J. E. Bartelt et. al. issued on Apr. 2, 2013 discloses the blends and uses of azeotropic formulations of methylperfluoroheptene ethers and trans-dichloroethylene. Cosolvents such as ethers and hydrocarbons, e.g., cyclopentane, are disclosed at column 7, lines 20-40.

U.S. Pat. No. 6,312,759 to T. Yamada et. al. issued on Nov. 6, 2001 discloses blends of 95 wt % or more heptafluorocyclopentane (HFCP) with many other solvents to be used as cleaning compositions or carrier fluids.

In addition to maximizing cleaning power and reducing flammability, the industry seeks cleaning products with minimal environmental impact. Ideally, cleaning products should have zero-ozone depleting potential and negligible global warming potential. Hydrochlorofluorocarbons with high ozone depleting potential have been replaced in the market with non-ozone depleting hydrofluorocarbons. Today, many hydrofluorocarbons are also being replaced due to their high global warming potential (HFC 43-10mee, commonly known as Vertrel XF has a Global Warming Potential (“GWP”) of 1640). GWP is defined by how much energy the emissions of one ton of gas will absorb over a given time, most commonly 100 years, relative to CO₂, which represents a GWP of 1. Hydrofluoroethers, hydrofluoroolefins and hydrochlorofluoroolefins have lower global warming potentials and are therefore preferable ingredients in cleaning products.

### SUMMARY OF THE INVENTION

The present invention concerns low flammability, low global warming cleaning solvent compositions exhibiting azeotrope-like behavior, for example in vapor degreaser operations, and the use of such cleaning solvents. The cleaning solvent compositions of the present invention are substantially non-fractionating or undergo only limited fractionation upon distillation, which is important for both the efficient and safe operation of cleaning operations and safety of various solvent packages such as bulk solvent, and solvent aerosol, wipes, and pump sprays. The solvent compositions of the present invention are also useful as carrier liquids for lubricants or other materials, for example, the application of lubricants in manufacturing operations. One embodiment of a cleaning solvent composition of the present invention comprises, consists essentially of, or consists solely of trans-dichloroethylene (sometimes below “TDCE”), heptafluorocyclopentane (sometimes below “HFCP”), 1-chloro-2,3,3-trifluoropropene (sometimes below “CTFP”), and, optionally, one or both of a suitable surfactant and a cosolvent. The content of 1-chloro-2,3,3-trifluoropropene is at least about 0.5 weight percent, for example, from about 0.5 to about 7 weight percent, from about 1 to about 7 weight percent, or from about 2 to about 7 weight percent or any amount falling within those ranges. It has been found that the presence of CTFP in the specified amount provides a durable azeotrope-like characteristic to the composition while maintaining non-flammability and a high KB value.

In accordance with one embodiment of the present invention there is provided a solvent composition having azeotrope-like properties and consisting essentially of at least about weight percent trans-dichloroethylene, at least about 1 weight percent 1,1,2,2,3,3,4-heptafluorocyclopentane (CAS #15290-77-4), at least about 0.5 weight percent of 1-chloro-2,3,3-trifluoropropene, and, optionally, one or both of a surfactant and a cosolvent.

Yet another embodiment of the present invention provides a solvent composition having azeotrope-like properties and consisting essentially of at least about 70 to about 97 weight percent trans-dichloroethylene, from about 1 to about 15 weight percent 1,1,2,2,3,3,4-heptafluorocyclopentane, from about 0.5 to about 15 weight percent of 1-chloro-2,3,3-trifluoropropene, and, optionally, one or both of a surfactant and a cosolvent. One embodiment of a cleaning solvent composition of the present invention comprises from about 80 to about 97 weight percent trans-dichloroethylene, from about 1 to about 13 weight percent of heptafluorocyclopentane, and from about 2 to about 7 weight percent of 1-chloro-2,3,3-trifluoropropene.

Certain embodiments of the present invention may optionally contain one or both of a surfactant and a cosolvent in addition to the following components. One embodiment contains from about 88 to about 95.2 weight percent trans-dichloroethylene, from about 2.3 to about 6 weight percent heptafluorocyclopentane, and from about 2.5 to about 6 weight percent of 1-chloro-2,3,3-trifluoropropene. Another embodiment contains about 91 to about 93 wt %, e.g., about 92 wt % by weight trans-dichloroethylene, about 3.5 to about 4.5 wt %, e.g., about 4 wt %, by weight heptafluorocyclopentane, and about 3.5 to about 4.5 wt %, e.g., about 4 wt %, by weight 1-chloro-2,3,3-trifluoropropene. Still another embodiment contains about 87 to about 91 wt %, e.g., about 89 wt %, by weight trans-dichloroethylene, about 4.5 to about 6.5 wt %, e.g., about 5.5 wt % by weight heptafluorocyclopentane, and about 4.5 to about 6.5 wt %, e.g., about wt % by weight, 1-chloro-2,3,3-trifluoropropene.

Another embodiment of a cleaning solvent composition of the present invention comprises any one of the aforementioned embodiments in which the surfactant, when present, is in a concentration of about 0.1 to 3 weight percent. Suitable surfactants are well known in the art and may be incorporated in the indicated amount without adversely affecting the cleaning power, flammability, low global warming potential, or azeotrope-like characteristics of the present invention.

Another embodiment of a cleaning solvent composition of the present invention comprises any one of the aforementioned embodiments in which a cosolvent, when present, is in an amount of about 1 to 50 weight percent of the weight of the other ingredients of the solvent blend. This embodiment of the present invention is sometimes herein referred to as “the high cosolvent blend”. In this embodiment the boil sump of a vapor degreasing unit is supplied with the high cosolvent blend and the cosolvent has a boiling point high enough that it does not distill over to the boil sump. Suitable cosolvents include but are not limited to. (a) N,N dimethyl 9-decenamide trade name Steposol MET-10U (b) a mixture of about greater than 80 weight percent polyoxyethylene tridecyl ether phosphate (CAS #9046-01-9), less than about 18 weight percent alcohol ethoxylate (CAS #78330-21-9), less than about 1 weight percent phosphoric acid (CAS #7664-38-2, and less than about 1 weight percent water (c) benzyl alcohol, and (d) hexylene glycol.

Unless otherwise specifically stated, or clear from the context, all percentages of a given component, whether expressed as “%”, “wt %”, “weight %”, “weight percent” or otherwise, are percent by weight of the component in the solvent composition, based on the total weight of the composition.

As used herein, the term “azeotrope-like” behavior or characteristics or language of similar import used with reference to the cleaning solvent blends of the present invention means that while the solvent blends may not exhibit perfect azeotropic characteristics (although some of the blends of the present invention may do so), the changes in composition after repeated distillation steps are small or limited. Generally, the term “azeotrope” “means a constant boiling, or substantially constant boiling liquid admixture of two or more substances that behaves under distillation as if it were a single substance. That is, the vapor produced by distillation of the liquid has substantially the same composition as the liquid from which it was distilled. Stated otherwise, there is no substantial composition change as the admixture is distilled. Further, an azeotropic composition may be characterized as a composition having a boiling point temperature of less than the boiling point of each pure component of the composition.

As a practical matter, it usually is acceptable if, for example, a change of not more than 20 wt % in the initially present quantity of each component of the blend is sustained over a protracted distillation (evaporation, condensation) period. Such compositions, i.e., blends, are herein referred to as “azeotrope-like compositions” or “azeotrope-like blends.” To illustrate, refer to Example 5 below. The TDCE component is initially present in the amount of 89.94 wt % of the blend and after the seven-hour distillation period is present in the rinse sump of the vapor degreaser in the amount of 88.97 wt %. Dividing 88.97 wt % by 89.94 wt % shows that 98.92 wt % of the component remains. The reduction in TDCE content is 1.1 wt % in the rinse sump. After the seven-hour distillation period, the TDCE component in the boil sump of the vapor degreaser has increased to only 91.96 wt %, a 2.02 wt % difference from the starting amount of 89.94 wt %. The same calculation for the HFCP component shown in Example 5 gives a change of 4.0/5.0=0.80 or a decrease of 20 wt % in the boil sump and an increase of 5.5/5.0=1.1 or 9 wt % in the rinse sump. Similar calculations for AS-300 in Example 5 yield a decrease of AS-300 in the boil sump of 20 wt % and an increase in the rinse sump of 9 wt %. (As noted below, “AS-300” is 1-chloro-2,3,3-trifluoropropene.) Changes in composition of the components in Example 5 ranged from 1.1 wt % (TDCE boil sump) to 20 wt % gain or loss, as in the changes in HFCP and AS-300 content from the original 5 wt % content of these components.

The solvent compositions of the present invention may contain other ingredients, such as surfactants and cosolvents as noted above, provided that the type and quantity of such other ingredients do not adversely affect the azeotrope-like characteristics or cleaning efficacy of the compositions. That is, the solvent blends of the present invention may either comprise or consist essentially of the specified ingredients and in some cases may consist of only the specified ingredients except for trace impurities found in commercially available ingredients used to make the solvent blends of the present invention. A propellant may be used to deliver the solvent compositions of the present invention. Inasmuch as such propellants evaporate they do not affect the azeotrope-like characteristics or cleaning efficacy of the solvent compositions.

### BRIEF DESCRIPTION OF THE DRAWINGS

FIG. 1 is a schematic view in elevation of a bench top simulation of a standard 2-sump vapor degreaser comprising a dual bulb apparatus of the type used to develop the data illustrated in FIGS. 2 and 3;

FIG. 2 is a graph plotting the change in composition of a cleaning solvent embodiment of the present invention (Example 5) measured in the rinse sump of a vapor degreaser against the time period of repeated distillation and condensation; and

FIG. 3 is a graph identical to that of FIG. 2 except that the change in composition is measured in the boil sump of the vapor degreaser.

### DETAILED DESCRIPTION OF THE INVENTION AND SPECIFIC EMBODIMENTS THEREOF

The following abbreviations, trademarks and trade names have the following meanings, whether used in the singular or plural form.

“TDCE”. Trans-Dichloroethylene. Chemical Abstracts Number (“CAS #”) 156-60-5.
“XF”. The hydrofluorocarbon, 2,3-dihydrodecafluoropentane (HFC-4310-mee) [Tradename Vertrel XF]. CAS #1384-95-42.
“AS-300”. A blend of cis- and trans-stereoisomers of 1-chloro-2,3,3-trifluoropropene composed of >89 wt (Z)-1-chloro-2,3,3-trifluoropropene and <10 wt % (E)-1-chloro-2,3,3-trifluoropropene, as supplied by AGC, Inc. Chemicals Company under the tradename “Amolea AS-300”.
“SF33”. The hydrofluoroolefin, (Z)-1,1,1,4,4,4-Hexafluoro-2-butene; Tradename Opteon SF33 by Chemours Company. CAS #692-49-9.
“HFX-110”. Methylperfluoroheptene ethers; Tradename HFX-110. CAS #Proprietary.
“HFCP”. 1,1,2,2,3,3,4-Heptafluorocyclopentane. Tradename Zeorora. CAS #15290-77-4.
“Vertrel® SFR”. A blend of 67 wt % trans-dichloroethylene, 18 wt % 2,3-dihydrodecafluoropentane (HFC-4310-mee); 12 wt % heptafluorocyclopentane; 3 wt % methanol. This material has a boiling point of 106° F. (41.1° C.) and is available from Chemours Corporation of Wilmington, Delaware.
“Opteon SF79”. A blend of nominally 95.2 wt % trans-dichloroethylene, 4.0 wt % methylperfluoroheptene ethers (HFX-110) and 0.8 wt % 2,3-dihydrodecafluoropentane (HFC 43-10mee). This material has a boiling point of 121° F. (49.4° C.) and is available from Chemours Corporation of Wilmington, Delaware.
“Opteon SF80”. A blend of nominally 95.2 wt % trans-dichloroethylene, 4.0 wt % methylperfluoroheptene ethers (HFX-110) and 0.8 wt % (Z)-1,1,1,4,4,4-Hexafluoro-2-butene (Opteon SF33). This material has a boiling point of 121° F. (49.4° C.) and is available from Chemours Corporation of Wilmington, Delaware.

### “MeOH”. Methyl Alcohol.

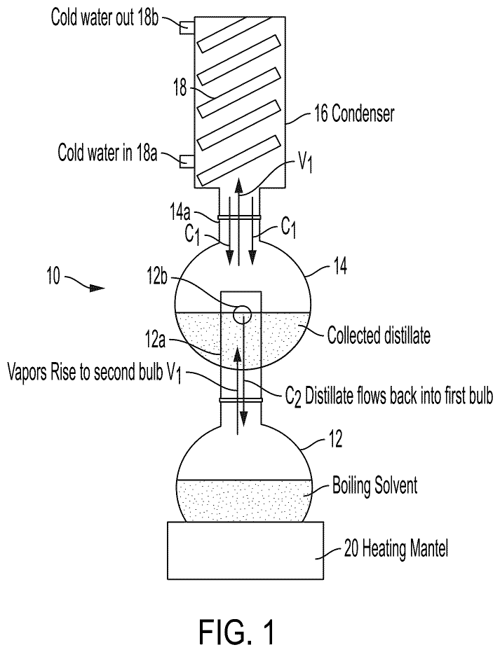

FIG. 1 shows laboratory glassware 10 comprising a boil bulb 12 having a neck 12a which protrudes into rinse bulb 14. Neck 12a has formed therein an aperture 12b which is disposed within rinse bulb 14. A condenser 16 is fitted to rinse bulb 14 at the outlet end 14a thereof and comprises a cooling coil 18 disposed within condenser 16. A cold water inlet 18a is connected to a source of cooling water (not shown) and a cold water outlet 18b is connected to a water discharge (not shown). Boil bulb 12 is disposed upon a heating mantel 20.

In use, a solvent composition to be tested is introduced into boil bulb 12 and heated to boil the solvent composition and generate a vapor which rises to rinse bulb 14 and then into condenser 16 as indicated by arrows V 1. Vapor is condensed by contact with cooling coil 18 and flows into rinse bulb 14 as indicated by arrows C1. When the condensate collected in rinse bulb 14 reaches the level of aperture 12b, the overflow solvent flows back into boil bulb 12 as indicated by arrow C2.

Standard Test Procedure. Trials were conducted in standard 2-sump vapor degreasers or in bench top simulation using a “dual bulb” apparatus of the type illustrated in FIG. 1 having a standard solvent still head with collection flask and sampling port (not shown in FIG. 1) on the boil flask. Samples from various locations and times are analyzed by gas chromatography using an Agilent Corporation DB-200 capillary column (trifluoropropyl methyl dimethyl siloxane stationary phase) and an FID detector. The following examples report the results of trials conducted pursuant to this Standard Test Procedure.

### Comparative Example 1. Distillation of Vertrel SFR in a Vapor Degreaser

Composition of Vertrel SFR Over
Time in Branson B-452R Degreaser

| | | wt % TDCE | | wt % HFCP | | wt % XF | | wt % MeOH | |
|---|---|---|---|---|---|---|---|---|---|
| | | Virgin (Drum) | | | | | | | |
| | | 67.7 | | 12.2 | | 17.3 | | 2.8 | |
| Time | | Boil | Rinse | Boil | Rinse | Boil | Rinse | Boil | Rinse |
| Distilled | | Sump | Sump | Sump | Sump | Sump | Sump | Sump | Sump |
| 1 | hour | 75.8 | 68 | 16.5 | 12.2 | 6.6 | 16.7 | 0.9 | 2.9 |
| 2 | hours | 76.4 | 67.6 | 16.8 | 12.1 | 5.9 | 17.2 | 0.8 | 3 |
| 5 | hours | 77.3 | 68.3 | 16.4 | 11.7 | 5.4 | 16.9 | 0.7 | 3 |
| 7 | hours | 77.3 | 68.3 | 16.5 | 11.7 | 5.3 | 16.9 | 0.7 | 3 |
| 9 | hours | 76.9 | 67.9 | 16.9 | 12.1 | 5.4 | 16.9 | 0.7 | 2.9 |
| 12 | hours | 77.9 | 68.3 | 15.9 | 11.5 | 5.3 | 17.1 | 0.7 | 3 |
| 17 | hours | 78.2 | 68.7 | 15.6 | 11.1 | 5.3 | 17.1 | 0.7 | 3.1 |

It can be seen that this blend of solvents, although remaining substantially azeotrope-like in behavior, changes its vapor composition quickly and dramatically. The ratios partition between the boil and rinse sump with the TDCE levels changing by more than 10 wt % from the original values (67.7 weight % to 78.2 weight %).

### Comparative Example 2. Distillation of Opteon SF79

Composition of Opteon SF79 over time in a vapor degreaser

| | | wt % TDCE | | wt % HFX-110 | | wt % XF | |
|---|---|---|---|---|---|---|---|
| | | Virgin (Drum) | | | | | |
| | | 95.1 | | 4.1 | | 0.8 | |
| Time | | Boil | Rinse | Boil | Rinse | Boil | Rinse |
| Distilled | | Sump | Sump | Sump | Sump | Sump | Sump |
| 4.5 | hours | 95.64 | 95.05 | 4.23 | 4.03 | 0.13 | 0.92 |
| 13 | hours | 95.63 | 95.29 | 4.27 | 4.08 | 0.1 | 0.63 |
| 21.5 | hours | 95.61 | 95.28 | 4.24 | 4.1 | 0.15 | 0.62 |
| 29.5 | hours | 95.6 | 95.35 | 4.27 | 4.1 | 0.13 | 0.55 |

| | | | | | | |
|---|---|---|---|---|---|---|
| wt % | +0.5 | +0.3 | +4.1 | 0 | −83.7 | −31.2 |
| change | | | | | | |

It can be seen that this product blend also changes ratio between the “boil” and “rinse” flasks. Most dramatically, the Vertrel XF which is present to improve the non-flammable characteristic of the blend, has been substantially depleted in the boil sump.

### Comparative Example 3. Distillation of Opteon SF80

Composition of Opteon SF80 over time in a vapor degreaser

| | wt % TDCE | | wt % HFX-110 | | wt % SF33 | |
|---|---|---|---|---|---|---|
| | Virgin (Drum) | | | | | |
| | 95.04 | | 4.1 | | 0.87 | |
| Time | Boil | Rinse | Boil | Rinse | Boil | Rinse |
| Distilled | Sump | Sump | Sump | Sump | Sump | Sump |
| 1 hours | 95.54 | 95.28 | 4.43 | 4.01 | 0.03 | 0.71 |
| 2 hours | 95.54 | 95.15 | 4.40 | 4.03 | 0.03 | 0.82 |
| 3 hours | 95.57 | 95.10 | 4.37 | 4.05 | 0.04 | 0.85 |
| 4 hours | 95.60 | 95.15 | 4.36 | 4.05 | 0.03 | 0.80 |
| wt % | +0.6 | +0.1 | +6.3 | −1.2 | −96.6 | −8.0 |
| change | | | | | | |

It can be seen that this product blend also changes ratio between the “boil” and “rinse” flasks. Most dramatically, the SF33 which is present to improve the non-flammable characteristic of the blend, has been substantially depleted in the boil sump.

### Example 4. Distillation of Blend 18-63-1 in a Dual-Bulb Apparatus

Blend 18-63-1 is nominally a blend of 92 wt % trans-dichloroethylene, 4 wt % heptafluorocyclopentane and 4 wt % 1-chloro-2,3,3-trifluoropropene

Composition of 18-63-1 over time in a dual-bulb apparatus

| | | wt % TDCE | | wt % HFCP | | wt % AS-300 | |
|---|---|---|---|---|---|---|---|
| | | Virgin (Drum) | | | | | |
| | | 91.97 | | 3.92 | | 4.11 | |
| Time | | Boil | Rinse | Boil | Rinse | Boil | Rinse |
| Distilled | | Sump | Sump | Sump | Sump | Sump | Sump |
| 1 | hours | 95.41 | 90.13 | 2.12 | 4.91 | 2.47 | 4.95 |
| 2 | hours | 94.98 | 90.71 | 2.35 | 4.61 | 2.67 | 4.67 |
| 3 | hours | 94.71 | 91.02 | 2.49 | 4.45 | 2.80 | 4.53 |
| 4 | hours | 94.57 | 91.16 | 2.57 | 4.38 | 2.86 | 4.46 |
| 5 | hours | 94.65 | 91.41 | 2.53 | 4.20 | 2.82 | 4.39 |
| 6 | hours | 94.63 | 91.46 | 2.54 | 4.19 | 2.83 | 4.35 |
| 7 | hours | 94.77 | 91.52 | 2.47 | 4.16 | 2.76 | 4.32 |
| 8 | hours | 94.91 | 91.61 | 2.39 | 4.11 | 2.70 | 4.28 |
| 9 | hours | 95.00 | 91.69 | 2.35 | 4.05 | 2.65 | 4.26 |
| 10 | hours | 95.18 | 91.77 | 2.27 | 4.02 | 2.55 | 4.20 |
| 11 | hours | 94.65 | 91.82 | 2.54 | 4.00 | 2.81 | 4.18 |

| | | | | | | |
|---|---|---|---|---|---|---|
| wt % | +2.9 | −0.2 | −35.2 | +2.0 | −31.6 | +1.7 |
| change | | | | | | |

As shown by Example 4, this embodiment of the present invention redistributes ratios to a smaller degree than Opteon SF79 or Opteon SF80. The cleaning power and non-flammable behavior is maintained in all locations of the vapor degreaser.

### Example 5. Distillation of Blend 18-70-1 in a Dual-Bulb Apparatus

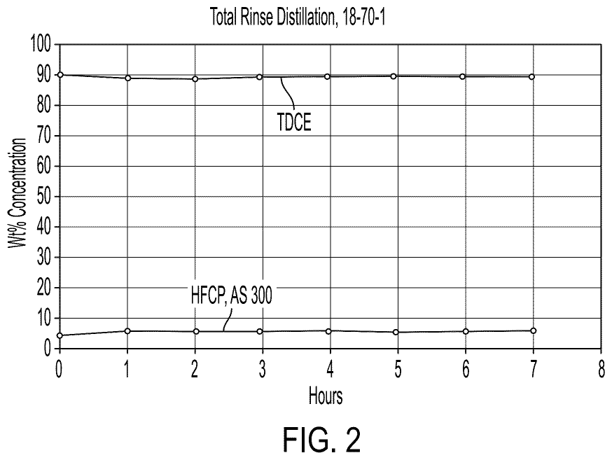

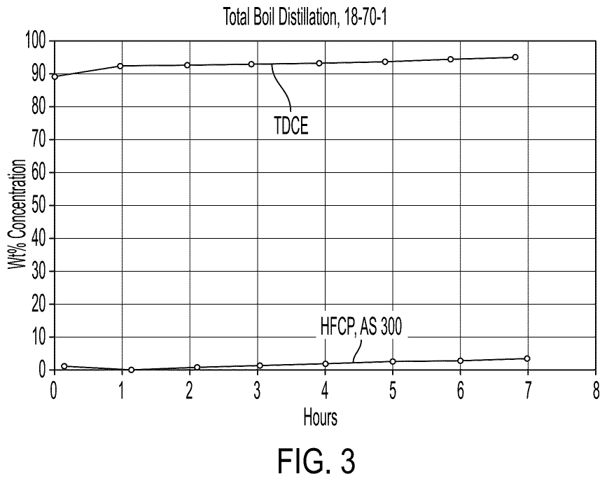

Blend 18-70-1 is nominally a blend of 92 wt % trans-dichloroethylene, 5 wt % 1,1,2,2,3,3,4-heptafluorocyclopentane and 5 wt % 1-chloro-2,3,3-trifluoropropene. FIGS. 2 and 3 are graphs which plot the values of the following table, the rinse sump data being shown in FIG. 2 and the boil sump data being shown in FIG. 3. It is seen that in both FIGS. 2 and 3 the values for HFCP and AS-300 substantially overlie each other.

Composition of 18-70-1 over time in a dual-bulb apparatus

| | wt % TDCE | | wt % HFCP | | wt % AS-300 | |
|---|---|---|---|---|---|---|
| | Virgin (Drum) | | | | | |
| | 89.94 | | 5.05 | | 5.01 | |
| Time | Boil | Rinse | Boil | Rinse | Boil | Rinse |
| Distilled | Sump | Sump | Sump | Sump | Sump | Sump |
| 1 hours | 92.45 | 88.32 | 3.75 | 5.89 | 3.79 | 5.79 |
| 2 hours | 91.99 | 88.69 | 3.99 | 5.69 | 4.02 | 5.61 |
| 3 hours | 91.89 | 88.82 | 4.05 | 5.63 | 4.06 | 5.55 |
| 4 hours | 91.79 | 88.83 | 4.09 | 5.65 | 4.12 | 5.52 |
| 5 hours | 91.78 | 88.84 | 4.10 | 5.65 | 4.12 | 5.51 |
| 6 hours | 91.86 | 88.81 | 4.06 | 5.66 | 4.08 | 5.53 |
| 7 hours | 91.96 | 88.97 | 4.00 | 5.55 | 4.04 | 5.48 |
| wt % | +2.2 | −1.1 | −20.8 | +9.9 | −19.4 | +9.4 |
| change | | | | | | |

Example 5 shows a smaller overall shift in composition of this embodiment of in the present invention as compared to composition 18-63-1 (Example 4) or Opteon SF79 (Comparative Example 2) or Opteon SF80 (Comparative Example 3). The blend of this Example 5, as is the case with the other embodiments of the present invention, redistributes and stabilizes the components to form consistent rinse and boil compositions.

### Example 6

The composition of the solvent blend of this embodiment of the present invention stays nearly the same after 13 hours of distillation even with the addition of paraffin wax as a contaminant.

Composition of 18-70-1 over time in dual-
bulb with contamination additions

| Hours | wt % | wt % | wt % | wt % | Boiling |
|---|---|---|---|---|---|
| distilled | TDCE | AS300 | HFCP | wax added | Temp (C.) |
| 0 | 89.88 | 5.05 | 5.07 | 0 | 45 |
| 1 | 88.33 | 5.78 | 5.89 | 0 | 45 |
| 2 | 88.66 | 5.62 | 5.72 | 1 | 45 |
| 3 | 88.68 | 5.59 | 5.72 | 2 | 45 |
| 4 | 88.69 | 5.58 | 5.73 | 3 | 45 |
| 5 | 88.76 | 5.58 | 5.65 | 4 | 45 |
| 6 | 88.76 | 5.59 | 5.66 | 5 | 45 |
| 7 | 88.42 | 5.72 | 5.86 | 5 | 45 |
| 8 | 88.57 | 5.65 | 5.78 | 6 | 45 |
| 9 | 88.67 | 5.59 | 5.74 | 7.6 | 45 |
| 10 | 88.71 | 5.58 | 5.71 | 9 | 45 |
| 11 | 88.78 | 5.58 | 5.64 | 11 | 45 |
| 12 | 88.88 | 5.52 | 5.6 | 12 | 45 |
| 13 | 88.85 | 5.52 | 5.63 | 15.5 | 45 |
| wt % change | −1.1 | +9.3 | +11.0 | +15.5 | 0 |

Example 6 shows that the invention presents very little composition shift even when high concentrations of contamination are added to the boil sump. This example demonstrates that the azeotropic blend maintains stability during use.

### Example 7

The embodiment of the present invention maintains good stability of the composition during fractional distillation.

Composition of 18-70-1 during fractional distillation

| Fraction | wt % | wt % | wt % | wt % |
|---|---|---|---|---|
| Hours Distilled | TDCE | AS300 | HFCP | Solvent remaining |
| Start | 89.96 | 5.01 | 5.03 | 100 |
| 1 | 87.26 | 6.3 | 6.43 | 61.8 |
| 2 | 88.4 | 5.71 | 5.89 | 49.8 |
| 3 | 89.22 | 5.3 | 5.48 | 38.5 |
| 4 | 90.16 | 4.88 | 4.96 | 27.4 |
| 5 | 91.43 | 4.28 | 4.28 | 16.0 |
| 6 | 93.47 | 3.34 | 3.19 | 4.1 |
| 7 | 96.38 | 1.98 | 1.64 | 0.1 |

Example 7 shows that the present invention maintains azeotrope-like composition during fractional distillation. The composition exhibits little shift even when 84 wt % of the bulk solvent has evaporated.

### Example 8

The present invention maintains non-flammability even after the compositions shifts during distillation.

Flammability of 18-70-1 distillation fractions by “pan test”

| Fraction | wt % | wt % | wt % | |
|---|---|---|---|---|
| Hours Distilled | TDCE | AS300 | HFCP | Flammable? |
| Start | 89.96 | 5.01 | 5.03 | Non-flammable |
| 1 | 87.26 | 6.3 | 6.43 | Non-flammable |
| 2 | 88.4 | 5.71 | 5.89 | Non-flammable |
| 3 | 89.22 | 5.3 | 5.48 | Non-flammable |
| 4 | 90.16 | 4.88 | 4.96 | Non-flammable |
| 5 | 91.43 | 4.28 | 4.28 | Non-flammable |
| 6 | 93.47 | 3.34 | 3.19 | Non-flammable |
| 7 | 96.38 | 1.98 | 1.64 | Non-flammable |

The formulas listed in Example 8 were tested for potential flammability using the “pan test”. A metal pan was filled with 10 mL of solvent in a fume hood. A flame source was passed over the surface of the liquid and the flame was monitored for size and duration. Once the flame extinguished, the fumes were allowed to dissipate for 30 seconds. The flame source was then passed over the solvent surface again. This process was repeated until all of the solvent had evaporated. The testing was ceased if the flames did not self-extinguish within 10 seconds. A solvent which self-extinguished the flames in less than 5 seconds was deemed “non-flammable.” A solvent which did not extinguish the flames after 5 seconds was deemed “flammable.” This test method is an internal specification to gauge flammability potential for solvent blends before testing via closed-cup or open-cup methods. Example 8 demonstrates that the distillation fractions of 18-70-1 are likely to be non-flammable.

### Example 9

Efficacious embodiments of the present invention include the following solvent blends, each of which shows good cleaning properties, non-flammability, low global warming potential, and azeotrope-like properties. Each of the following solvent blends optionally may include one or both of a suitable surfactant and cosolvent in amounts which do not adversely affect the above noted desirable properties.
A. A solvent blend exhibiting azeotrope-like properties containing:
   from about 70 to about 95.7 weight percent trans-dichloroethylene;
   from about 15 to about 3.8 weight percent heptafluorocyclopentane; and
   from about 15 to about 0.5 weight percent 1-chloro-2,3,3-trifluoropropene.
B. A solvent blend of exhibiting azeotrope-like properties containing:
   from about 88 to about 94.2 weight percent trans-dichloroethylene;
   from about 6 to about 3.8 weight percent heptafluorocyclopentane; and
   from about 6 to about 2 weight percent 1-chloro-2,3,3-trifluoropropene.
C. A solvent blend exhibiting azeotrope-like properties containing:
   from about 91 to about 92.7 weight percent trans-dichloroethylene;
   from about 4.5 to about 3.8 weight percent heptafluorocyclopentane; and
   from about 4.5 to about 3.5 weight percent 1-chloro-2,3,3-trifluoropropene.
D. A solvent blend-exhibiting azeotrope-like properties containing:
   from about 70 to about 95.5 weight percent trans-dichloroethylene;
   from about 15 to about 4 weight percent heptafluorocyclopentane; and
   from about 15 to about 0.5 weight percent 1-chloro-2,3,3-trifluoropropene.
E. A solvent blend exhibiting azeotrope-like properties containing:
   about 92 weight percent trans-dichloroethylene;
   about 4 weight percent heptafluorocyclopentane; and
   about 4 weight percent 1-chloro-2,3,3-trifluoropropene.
F. A solvent blend exhibiting azeotrope-like properties containing:
   from about 88 to about 92 weight percent trans-dichloroethylene;
   from about 6 to about 4 weight percent heptafluorocyclopentane; and
   from about 6 to about 4 weight percent 1-chloro-2,3,3-trifluoropropene.
G. A solvent blend exhibiting azeotrope-like properties containing:
   about 90 weight percent trans-dichloroethylene;
   about 5 weight percent heptafluorocyclopentane; and
   about 5 weight percent 1-chloro-2,3,3-trifluoropropene.

### Example 10

A. The solvent blend of any one of Examples 9A-9G further containing at least one surfactant in an amount of 0.1 to about 3 weight percent.
B. The solvent blend of any one of Examples 9A-9G further containing at least one cosolvent in an amount of 1 to about 50 weight percent.

### Example 11

The following are methods of cleaning soiled articles which methods are exemplary of the present invention.
A. A method for cleaning soiling substances from metal, ceramic and synthetic polymer articles comprises contacting one or more of the articles with a solvent composition having azeotrope-like properties, the composition containing:
   from about 70 to about 95.7 weight percent trans-dichloroethylene;
   from about 15 to about 3.8 weight percent heptafluorocyclopentane;
   from about 15 to about 0.5 weight percent 1-chloro-2,3,3-trifluoropropene; and
   removing the composition from the one or more articles.
B. A method identical to that of Example 11A except that the solvent composition contains:
   from about 88 to about 94.2 weight percent trans-dichloroethylene;
   from about 6 to about 3.8 weight percent heptafluorocyclopentane; and
   from about 6 to about 2 weight percent 1-chloro-2,3,3-trifluoropropene.
C. A method identical to that of Example 11A except that the solvent composition contains:
   from about 91 to about 92.7 weight percent trans-dichloroethylene;
   from about 4.5 to about 3.8 weight percent heptafluorocyclopentane; and
   from about 4.5 to about 3.5 weight percent 1-chloro-2,3,3-trifluoropropene.
D. A method identical to that of Example 11A except that the solvent composition contains:
   about 90 weight percent trans-dichloroethylene;
   about 5 weight percent heptafluorocyclopentane; and
   about 5 weight percent 1-chloro-2,3,3-trifluoropropene.
E. A method identical to that of Example 11A except that the solvent composition contains:
   from about 88 to about 92 weight percent trans-dichloroethylene;
   from about 6 to about 4 weight percent heptafluorocyclopentane; and
   from about 6 to about 4 weight percent 1-chloro-2,3,3-trifluoropropene.

While the invention has been described in detail with reference to specific embodiments of the invention, these embodiments are exemplary and not limiting.

What is claimed is:

1. A solvent composition having azeotrope-like properties and consisting essentially of at least about 70 weight percent trans-dichloroethylene, at least about 1 weight percent 1,1,2,2,3,3,4-heptafluorocyclopentane, at least about 0.5 weight percent of 1-chloro-2,3,3-trifluoropropene, and, optionally, one or both of a surfactant and a cosolvent.

2. The composition of claim 1 wherein the trans-dichloroethylene is present in the amount of from about 70 to about 97 weight percent, 1,1,2,2,3,3,4-heptafluorocyclopentane is present in the amount of from about 1 to about 15 weight percent, and the 1-chloro-2,3,3-trifluoropropene is present in the amount of from about 0.5 to about 15 weight percent.

3. The composition of claim 1 or claim 2 wherein the cosolvent is present and is selected from the class consisting of one or more of (a) N,N dimethyl 9-decenamide trade name Steposol MET-10U (b) a mixture of about greater than 80 weight percent polyoxyethylene tridecyl ether phosphate, less than about 18 weight percent alcohol ethoxylate, less than about 1 weight percent phosphoric acid, and less than about 1 weight percent water (c) benzyl alcohol, and (d) hexylene glycol.

4. The composition of claim 1 or claim 2 wherein the surfactant, when present, is present in the amount of from about 0.1 to about 3 weight percent.

5. The composition of claim 4 wherein the cosolvent is present in an amount of about 1 to about 50 weight percent of the weight of the other ingredients of the composition.

6. The composition of claim 1 or claim 2 containing from about 70 to about 95.7 weight percent trans-dichloroethylene, from about 15 to about 3.8 weight percent heptafluorocyclopentane, and from about 15 to about 0.5 weight percent 1-chloro-2,3,3-trifluoropropene.

7. The composition of claim 1 or claim 2 containing from about 88 to about 94.2 weight percent trans-dichloroethylene, from about 6 to about 3.8 weight percent heptafluorocyclopentane, and from about 6 to about 2 weight percent 1-chloro-2,3,3-trifluoropropene.

8. The composition of claim 1 or claim 2 containing from about 91 to about 92.7 weight percent trans-dichloroethylene, from about 4.5 to about 3.8 weight percent heptafluorocyclopentane, and from about 4.5 to about 3.5 weight percent 1-chloro-2,3,3-trifluoropropene.

9. The composition of claim 1 or claim 2 containing from about 70 to about 95.5 weight percent trans-dichloroethylene, from about 15 to about 4 weight percent heptafluorocyclopentane, and from about 15 to about 0.5 weight percent 1-chloro-2,3,3-trifluoropropene.

10. The composition of claim 1 or claim 2 containing about 92 weight percent trans-dichloroethylene, about 4 weight percent heptafluorocyclopentane, and about 4 weight percent 1-chloro-2,3,3-trifluoropropene.

11. The composition of claim 1 or claim 2 containing from about 88 to about 92 weight percent trans-dichloroethylene, from about 6 to about 4 weight percent heptafluorocyclopentane, and from about 6 to about 4 weight percent 1-chloro-2,3,3-trifluoropropene.

12. The composition of claim 1 or claim 2 containing about 90 weight percent trans-dichloroethylene, about 5 weight percent heptafluorocyclopentane, and about 5 weight percent 1-chloro-2,3,3-trifluoropropene.

13. The composition of claim 1 or claim 2 wherein the 1-chloro-2,3,3-trifluoropropene is present in the amount of from about 2 to about 7 weight percent.

14. The composition of claim 1 wherein the trans-dichloroethylene is present in the amount of from about 80 to about 97 weight percent, 1,1,2,2,3,3,4-heptafluorocyclopentane is present in the amount of from about 1 to about 13 weight percent, and the 1-chloro-2,3,3-trifluoropropene is present in the amount of from about 2 to about 7 weight percent.

15. A method of cleaning an article of manufacture by contacting the article with the solvent composition of any one of claim 1 or claim 2 and then removing the solvent composition from the article.

16. The method of claim 15 wherein the contacting of the article with the solvent composition is carried out by vaporizing the composition and contacting the article with the resulting vapor, and after such contacting the vapor is condensed to liquid and drains from the article.
